(19) United States
(12) Patent Application Publication
(10) Pub. No.: US 2007/0169994 A1
(43) Pub. Date: Jul. 26, 2007

(54) Modular hunting stand and hunting gear transport cart

(76) Inventor: Todd Alan Oftedahl, Eldora, IA (US)

Correspondence Address: Raymond M. Galasso;Galasso & Associates LP, P.O. Box 26503, Austin, TX, 78755-0503, US

(21) Appl. No.: 11/340,055

(22) Filed: Jan. 26, 2006

(51) Int. Cl. E06C 7/16

(52) U.S. Cl. 182/116; 182/20

(57) ABSTRACT

A portable modular hunting stand is provided that breaks down into a game and hunting gear hauling apparatus for transportation into and out of a hunting site, that is provided with wheels or skis to facilitate the carrying of the weight of the gear and stand into and out of the woods, the stand being modular in design and providing for quick setup and disassembly.

### FIELD OF THE DISCLOSURE

The disclosures made herein relate generally to the field of apparatuses designed to provide game hunters with an elevated hunting perch, and in particular, to portable hunting stands having members configurable to additionally function as a hunting gear transport cart, the apparatus having a modular design allowing assembly, disassembly and reconfiguration into a tree leaning hunting stand in the field.

### BACKGROUND

Elevated tree stands are often used by hunters in spotting game and hunting game. More traditional hunting stands are often structures built in a tree or on stilts and are relatively permanent structures. Over time hunters have employed portable hunting stands which may be erected, used, disassembled and moved to other locations during hunting season. Frequently elevated stands are used in deer and large game hunting, and more often in bow hunting.

Certain known types of hunting stands are configured to lean against or otherwise attach to the trunk of a tree for support.

U.S. Pat. No. 4,331,216 discloses a deer hunting stand having a first and second climbing element, which the user must manipulate and work in sequence to raise himself and the stand off the ground and therewith up a tree to the desired height. The climbing stand disclosed in U.S. Pat. No. 4,331,216 has a further drawback in that the stand can not climb beyond the height of small branches or branch stubs projecting out from a tree trunk permit, and is therefore not readily usable with many otherwise suitable trees and otherwise suitable wooded locations.

Other types of hunting stands are relatively permanently constructed stands, possibly constructed in a tree, supported against a tree, or freestanding. A limitation of these more permanent hunting stands is that they are fixed in one location and are not readily or easily moved to another possibly more productive hunting location. Another limitation is the time required to erect such a fixed structure.

U.S. Pat. No. 6,445,361 discloses a mobile hunting stand that can be suspended in a desired location from a tree by a rope or chain. A limitation of this stand is that it must be carried by the hunter into the site, and does not provide a means to assist the hunter in carrying additional gear into and out of the site.

As discussed above, portable hunting stands of various designs are known. A limitation of conventional portable hunting stands is that they are usually of a design which must be carried into the woods by the hunter as they lack a means of easily transporting the stand into and back out of the hunting site.

Another limitation of certain other known hunting stands is that they attach or anchor the stand to the tree by use of spikes in the tree interface members which embed through the bark of the tree and into the sap wood, thereby wounding the tree and opening the tree to disease and insect infestations.

Yet another limitation of some hunting stands is that they are not designed to be light is weight, and do not provide a suitable means for conveying the stand into and out of the woods.

Therefore, a portable hunting stand which is light in weight, having members which reconfigure readily from a stand into a game and gear transport cart, that is easily transported from the automobile to the site using provided handles and one or more large wheels for rolling weight support, that is stable during rolling transport into the site by the use of two large front wheels on opposing sides, that is easily erected at the site against a tree trunk to provide a stable support for the hunter, that is designed to be adaptable to the wide majority of trees and not limited by occasional low level branches, a stand that can be reconfigured to a small enough size for easy transport in an automobile, a stand with a design providing an easy means of ascent, a stand which by design sets up without the use of straps and anchors into the tree and avoids inflicting more than minimal damage to the tree to which it is supported against, such a portable modular hunting stand and transport cart assembly would be useful and novel.

### SUMMARY OF THE DISCLOSURE

Accordingly, embodiments of the inventive disclosures made herein comprise a portable modular hunting stand and game and hunting gear transport cart. The hunting stand is comprised of at least three major components: one or more ladder-like sections, a platform member designed to serve as a seat or stand, and a cart or chassis for transporting the stand, as well as for transporting equipment into the hunting site and game and equipment back out of the hunting site. In at least one embodiment the chassis can be a distinctly separate member from the ladder sections. In at least one other embodiment a ladder-like section is configured to additionally serve as the transport chassis member. Where transport chassis is discussed below, it is to be understood that in certain embodiments the transport chassis may be a ladder like chassis modified to additionally serve as a transport chassis and not a distinctly separate member.

In a portable modular hunting stand in accordance with the present inventive disclosure, the hunting stand breaks down into two or more ladder-like sections, and the sections stack on the transport chassis. In another embodiment one of the ladder-like sections is configured to also serve as the transport chassis, thereby eliminating a separate chassis member. The top section has a platform member on which the hunter may sit or stand when the hunting stand is assembled against a tree. The platform member serves as a backboard member after the stand is broken down onto the chassis.

The portable modular hunting stand, in accordance with the present inventive disclosure, converts to a gear and game transport cart after the hunting stand is stowed to the chassis. The cart is equipped with a pair of large removable wheels beneath the chassis to carry the weight of the stand and any transported gear, thereby removing this load from the hunter's hands. When configured as a cart, the portable modular hunting stand is equipped with two removable angled front handles which the hunter grasps to lift and guide the cart through the woods or field to the hunting site. The wheels and angled handles contribute to providing a design that makes it easy for a hunter to change locations in the field while hunting, such as to move the stand to a more productive location.

At least one ladder-like section has a removable guard rail or rails attached to the side or sides of the ladder-like section. The guard rails work together with the backboard member to retain and carry the hunter's gear and any game in place on the hunting stand cart during transport into or out of the hunting site. The cart is light in weight and with the large wheels is maneuverable over uneven terrain conditions. The cart storage area is on top of the ladder sections and defined by the backboard member and the side rails, is of sufficient size to carry all the gear across public or private lands to the hunting site in one trip. The goal is efficient use of time and resources—one trip in and one trip out, eliminating the needless work and wasted time of multiple trips to lug gear into and out of the hunting site. The narrow width of the hunting stand cart permits passage through some of the thickest wooded areas.

The portable modular hunting stand in accordance with the present inventive disclosure has a top platform member with a tree facing side having a concave edge form, so as to capture a tree trunk against which the hunting stand has been assembled, and thereby prevent the stand from sliding against the tree trunk and toppling when the stand is in use. The portable hunting stand is equipped with a ratchet strap assembly having ends secured to opposing sides of the platform, the strap is passed around the back of the tree trunk and then adjusted to take up slack an then tension the strap, pressing the platform against the tree trunk thereby improving stability of the hunting stand.

Turning now to specific embodiments of the inventive disclosures made herein, in at least one embodiment of the inventive disclosures made herein the hunting stand is easily setup and broken down into mating sections. In this embodiment the ladder sections are configured to retentively and supportively engaged end to end to form an extended height hunting stand. Sections may be added and removed to adjust the overall height of the platform member seat above the ground.

In at least one embodiment of the inventive disclosures made herein, the wheels can be advantageously replaced with skis when snowy weather conditions make the use of skis rather than wheels advantageous.

In at least one embodiment of the inventive disclosures made herein, the hunting stand chassis can be broken down or disassembled for easy concealment while hunting.

In at least one embodiment of the inventive disclosures made herein, the ladder sections are approximately 6 foot lengths, and in one embodiment using 3 sections achieve an approximate height of 15 feet. The platform member and ladder sections break down into sections having a length of approximately 6 feet for transport. Embodiments of the stand include sections which assemble to provide a stand having heights of 10, 13 and 15 feet. It is to be understood that this inventive disclosure is not limited to the use of three ladder sections, and number of sections from one to many may be used to achieve the hunting stand. Additionally, it is to be understood that the inventive disclosure is not limited to the use of the stand heights disclosed above. Other stand heights may be used without deviating from the design intent disclosed herein.

The hunting stand disclosed herein may be equipped with a rifle rest on the platform member. Alternately the hunting stand platform includes a bow holder.

In at least one embodiment of the inventive disclosures made herein, the hunting stand wheeled chassis includes hand brakes acting on the wheels as an assistive device in slowing the cart when descending a hill.

In certain embodiments of the invention the hunting stand cart includes a pinto hitch, the hitch providing the means to attach the cart to and pull the cart to the hunting site with a 4 wheel off-road all terrain vehicle or a snow mobile.

In at least one embodiment of the inventive disclosures made herein, the hunting stand comprises square aluminum or steel tubing forming the sides of the ladder members, and the platform member comprises tubing with steel mesh. Certain embodiments include a padded seat member on the platform to cushion the seat for the hunter; in other embodiments the hunter may prefer to bring and utilize his own seat cushion if needed and desired.

In at least one embodiment of the inventive disclosures made herein, the hunting stand comprises square aluminum or steel tubing forming the sides of the ladder members, and the platform member comprises tubing with steel mesh.

Accordingly, it is an objective of the inventive disclosures made herein to provide a hunting stand that is light in weight and easily transported to the hunting site.

It is another objective of the inventive disclosure made herein to provide a hunting stand that is not permanently constructed in one location but is instead portable and relocatable to various desired hunting locations during a hunting trip.

It is still another objective of the inventive disclosure made herein to provide a hunting stand that breaks down into smaller components for transport to the site by the hunter alone or the hunter using an ATV, and that comprises sections that easily reassemble in the field for use.

It is another objective of the inventive disclosure made herein to provide a hunting stand that provides an easy means of ascent for the hunter.

It is another objective of the inventive disclosure made herein to provide a hunting stand that does not require spikes to be used to fasten and secure the stand to the tree and thereby inflicts only minimal disturbances or damage to a tree to which it is attached.

It is another objective of the inventive disclosure made herein to provide a hunting stand that may be supported against the majority of trees encountered in the woods, and a hunting stand having a platform tree facing side having a concave edge form, so as to capture a tree trunk in the concave portion of the platform and resist sliding of the stand against the tree.

It is another objective of the inventive disclosure made herein to provide, in certain embodiments, a hunting stand than can be reconfigured to a small enough size for easy transport in an automobile, this accomplished by limiting the length of the modular members.

These and other objects of the invention made herein will become readily apparent upon further review of the following specification and associated drawings.

### BRIEF DESCRIPTION OF THE DRAWINGS

The drawings show a form of the invention that is presently preferred, however the invention is not limited to the precise arrangement shown in the drawings.

FIG. 1 presents a perspective view of one embodiment of the modular hunting stand and gear transport cart in accordance with the inventive disclosures herein.

FIG. 2 is an end view of one embodiment of the modular hunting stand and gear transport cart in accordance with the inventive disclosures herein.

FIG. 3 is a perspective view of one embodiment of the modular hunting stand setup for use and having a platform member supportively resting against a tree trunk.

### DETAILED DESCRIPTION OF THE DRAWINGS

In preparation for explaining the details of the present inventive disclosure, it is to be understood by the reader that the invention is not limited to the presented details of the construction, materials and construction details as illustrated in the accompanying drawings, as the invention concepts are clearly capable of other embodiments and of being practiced and realized in various ways by applying the disclosure presented herein.

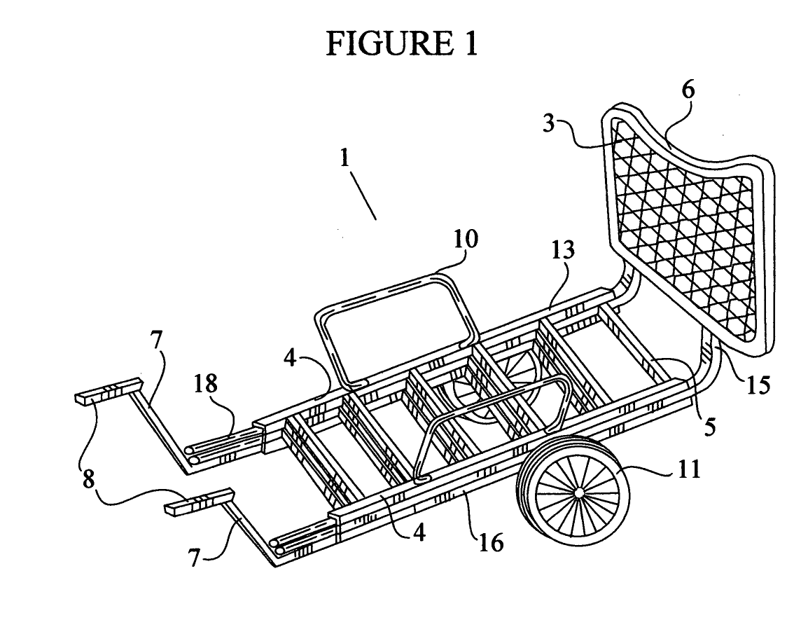

FIG. 1 depicts one particular embodiment of a modular portable hunting stand 1 broken down into modular ladder-like frame sections, the sections supportively stored on wheeled chassis, the assembly configured for transporting the modular stand and hunting gear into or back out of a hunting site. FIG. 1 depicts a modular hunting stand having two ladder-like frame members, namely a lower frame member 13 and an upper frame member 15. An upper end of the lower frame member is provided with rod or dowel like members 18, these members are sized and configured to insert into the lower end of the upper frame member legs. In at least one embodiment the legs are hollow tubular members, and the dowels or rods of an adjoining frame member extend into the legs to supportively and retentively join the frame members into an extended ladder structure, while allowing the extended ladder structure to be easily disassembled later after the hunt completes.

The ladder-like frame members provide a vertical ascent means to a hunting perch for a hunter, each member comprises two elongated leg members 4 sharing a common length along a major axis (the axis of elongation), the legs arranged in a fixed spaced parallel arrangement, and a plurality of step members 5 spanning between the leg members. The inventive disclosures herein are not limited to a particular number of ladder-like frame members, and may comprise any number of such ladder-like frame members joinable end to end. To achieve a hunting stand having a sufficient height to the platform while keeping section lengths convenient for transport, it is preferable to have three or more ladder-like frame members.

The ladder-like frame members assemble on the chassis 16 one on top of the other. As discussed above, the chassis itself may be a ladder-like member configured to additionally serve as a chassis, or the chassis can be a separate component of the modular hunting stand assembly. Modular hunting stands in accordance with the present inventive disclosure have an upper frame member 15 to which a platform member 3 is fixedly attached. The platform member 3 is sized and configured to provide an elevated seating or standing platform for a hunter from which he can wait for and target game. The platform member includes a concave tree facing side 6 which is configured to capture the face and sides of a tree trunk and serve as the interface between the hunting stand and the tree against which it is leaning and receiving support therefrom.

The chassis member 16 as depicted includes two wheels 11 proving low friction rolling support for the hunting stand and gear over a variety of terrains. The wheels are placed at opposing sides of the chassis, although in other embodiments the wheels may be placed under the chassis. The inventive disclosures herein are not limited to a chassis member having a particular number of wheels, and may comprise one wheel, three wheels (for one example having two in front and one centered in the rear of the chassis), 4 wheels (two spaced at opposing sides of the chassis front and two spaced at opposing sides of the chassis back), or more than four wheels.

In another embodiment the wheels 11 and their mounts are removable and may be replaced with skis for advantageously supportively conveying the hunting stand and chassis over snow covered terrain in Winter-like conditions.

The ladder-like sections may be retained upon the chassis by a variety of means. In one embodiment the ladder-like frame members are stacked upon the chassis member and aligned such that a bolt may be inserted through aligned holes in the legs of the frame members and into the chassis. The bolt may then be capped with a wing nut and hand or finger tightened to compress the frame sections to the chassis and thereby provide a rigid coupled assembly for transport into and out of the woods. Other means to retain the frame members to the chassis include vertical U shaped retainers fixed to the chassis into which the frame members may be stacked or the use of rubber straps and chords. The inventive disclosures herein are not limited to selected means of coupling and retaining the frame members on the chassis and may utilize any of the disclosed means or other retention means which would be known to one skilled in the art.

One ladder-like frame member 15 includes two or more guard rail members. FIG. 1 depicts two guard rail members secured to opposing upper frame member legs in a facing relationship. The guard rail members 15 cooperate with the platform member 3 to retain hunting gear and possibly game on the assembly during transport into or out of a hunting site.

Depicted in FIG. 1 are two angled handle members 7 securely and removably fixed to ends of a ladder-like frame member. The handle members include a means of removably securing one end of the handle member to a leg of the frame member, the other end of the handle member is angled upwards to a convenient height for hand grasp by a standing individual, this opposing end of the handle member is equipped with a hand grip portion 8 that may be padded or comprise a molded rubber hand hold conforming to the shape of the palm and fingers of a hand. The handle members are removably secured to the ladder-like frame members by inserting into the leg of the frame and, in one or more embodiments, passing one or more bolts through the leg and handle member to secure the handle member to the leg of the frame member. In at least one embodiment, the bolts holding the handle members to the legs are retained with finger tightened wing nuts on the retaining bolts. The inventive disclosures herein are not limited to the use of bolts and wing nuts to removably secure the handles to the frame member or chassis member, and other means may be employed as would be known to one skilled in the art.

The frame members, handles, steps and chassis of the modular hunting stand is constructed from available steel, alloys of steel or aluminum, or alternately the design can benefit from the use of lighter weight fiberglass construction. Plastics including polyethylene, polypropylene and other similar thermoplastic materials would be suitable for portions of the hunting stand, including but not limited to the platform, handle grips, and other components.

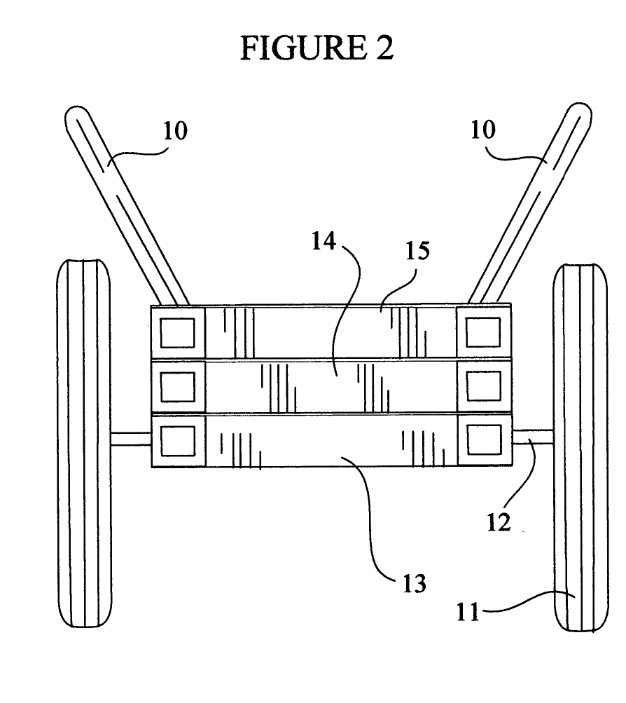

FIG. 2 depicts one particular embodiment of a modular portable hunting stand broken apart into modular ladder-like frame sections. In FIG. 2 one ladder-like frame section is configured with a removable wheel assembly 11 and serves as a chassis to transport the modular stand components and hunting gear into or back out of a hunting site. In this embodiment the legs of the frame sections are built from square tubular, possibly extruded metals including aluminum, alloys of steel, or alternately fiberglass or other materials as discussed above. Two wheels 11 disposed at opposite sides of the chassis are free to roll on axle 12, the axle secured to ladder-like frame member 13. FIG. 2 depicts a modular hunting stand having three ladder-like frame members, namely a lower frame member 13, a middle frame member 14, and an upper frame member 15.

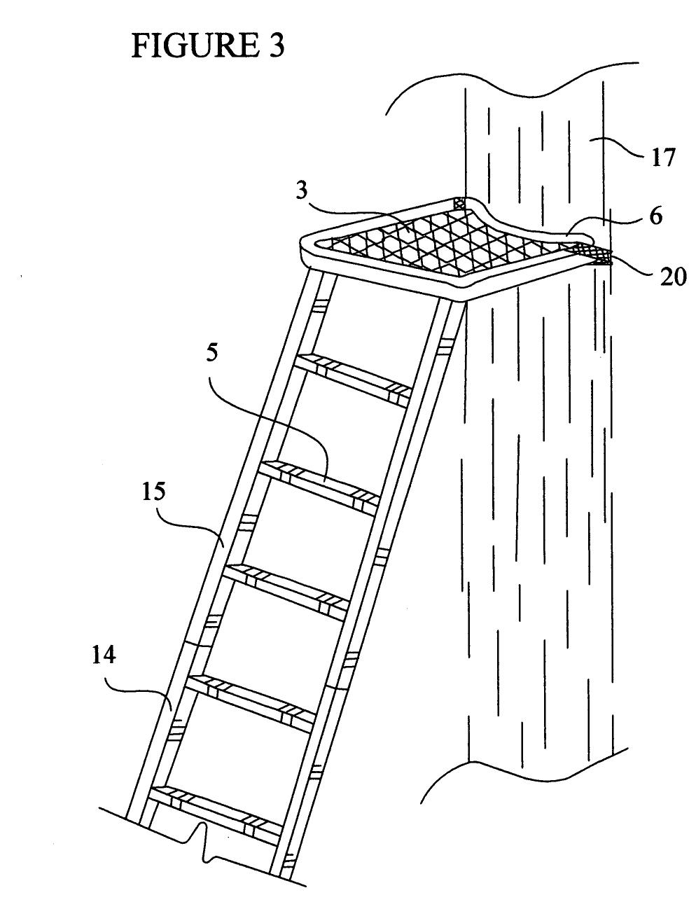

FIG. 3 depicts the modular hunting stand after assembly and with the platform member 3 of the upper frame member 15 in place and supportively resting against tree trunk 17, the concave tree facing side 6 of the platform member supportively resting against the tree trunk. For improved safety of the hunter or other user and for the added stability of the hunting stand a ratchet strap assembly 20 is secured to opposing sides of the platform near the tree trunk. A first half of the ratchet strap assembly consists of a strap secured to one side of the platform, this first half has a ratchet strap mechanism configured to receive and retentively engage a strap from a second half of the ratchet strap assembly. The second half of the ratchet strap assembly is secured to an opposing side of the platform and has a strap that wraps around the back side of the tree trunk to mate with the first half of the ratchet strap assembly and retentively engage the ratchet mechanism. The handle of the ratchet strap mechanism is then operated to take up slack in and to tension the strap and thereby press the tree stand platform against the tree trunk. Ratchet strap mechanisms are known. For illustration and enablement, one example of a ratchet strap mechanism that may be employed on for securing the hunting stand to a tree trunk is disclosed in U.S. Pat. No. 6,547,218.

FIG. 3 illustrates the upper section of middle frame member 14 supportively and removably joined to the upper frame member 15. The frame members are supportively interconnected by rod or dowel like 18 members as shown in FIG. 1. FIG. 3 illustrates the angled relationship of the platform member 3 relative to the upper frame member, the angle chosen to provide a platform seat or stand that is relatively horizontal and suitable for use as an elevated hunting seat or perch.

In a preferred embodiment, the modular hunting stand is constructed of tubular aluminum or steel, has three ladder-like frame members, and when assembled as in FIG. 3 reaches a height of around 15 feet above ground. In the preferred embodiment the platform member has a two foot width on which a hunter could sit comfortably while awaiting his prey. The three ladder-like frame sections have steps or rungs that allow the hunter to climb to the elevated platform. The preferred embodiment is equipped with side guard rails as discussed under FIG. 1 above, which together with the platform provide sides to the hunting stand assembly on the cart to retain stowed gear and materials on the trip into or out of the hunting site.

The discussed construction, illustrations and sequence of operation is for one embodiment of the invention, but is in no way limiting to other embodiments. The operating modes may be changed and enhanced without deviating from the intention of this inventive disclosure.

In the preceding detailed description, reference has been made to the accompanying drawings that form a part hereof, and in which are shown by way of illustration specific embodiments in which the invention may be practiced. These embodiments and certain variants thereof have been described in sufficient detail to enable those skilled in the art to practice the invention. It is to be understood that other suitable embodiments may be utilized and that logical, material, mechanical, software and electrical changes may be made without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A modular portable tree hunting stand that breaks down into sections for easy transport in and out of a hunting site, the stand comprising:
one or more ladder-like frame members for providing an ascent means for a hunter, each member comprising:
two elongated leg members sharing a common length along a major axis, the legs arranged in a fixed spaced parallel arrangement;
a plurality of step members, the step members sized to span between the leg members, the step members having two opposing ends, the step member ends securely and permanently mounted to the leg members, the step members spaced at intervals along the leg member major axis to provide supportive rungs for use in ascending the ladder-like member;
a means for removably, supportively and rigidly fixing another ladder-like frame member to one or more ends of the ladder-like frame member so as to extend the length of the ladder-like frame member;
a platform member rigidly secured to an end of one ladder-like frame member, the platform member having a tree facing side having a concave form and a seat surface, the tree facing side configured for supportively resting against the trunk of a tree, the platform member with seat surface secured to the ladder-like frame member at an angle to provide an essentially horizontal seat surface when the tree stand is in use, the platform member for providing an elevated perch for a hunter; and
a ratchet strap assembly having a first and a second half, the first half comprising a strap having one end secured to the a side of the platform member and an opposing end secured to a ratchet strap mechanism; the second half comprising a strap having one end secured to an opposing side of the platform member and an opposing end sized and configured to mate with and retentively engage the ratchet strap mechanism, the ratchet strap to wrap around a back side of a tree and secure the hunting stand platform to the tree.

2. The modular portable tree hunting stand of claim 1, further comprising:
two angled handle members, each member removably secured to adjacent ends of leg members of a ladder-like frame member, the handle members comprising:
a hand grip section secured to one end of the handle member; and
a means for removably securing the handle member to the leg member mounted to an opposing end of the handle member; and
a supportive means for conveying the one or more ladder-like frame members to a hunting site.

3. The modular portable tree hunting stand of claim 2 wherein one ladder-like frame member is adapted to provide the supportive means for conveying the ladder like frame members, the adapted frame member further comprising a low friction means for supportively conveying the hunting stand over terrain.

4. The modular portable tree hunting stand of claim 2 wherein the supportive means for conveying comprises a chassis member sized and configured for removable mounting to and transport support of one or more ladder-like frame members, the chassis member further comprising a low friction means for supportively conveying the hunting stand over terrain.

5. The modular portable tree hunting stand of claim 3 wherein said supportive means for conveying comprises an axle and at least one wheel secured thereto, the wheel and axle configured to support the chassis and facilitate low friction rolling transport over terrain, the axle removably secured to a bottom portion of the adapted frame member.

6. The modular portable tree hunting stand of claim 5 wherein the at least one wheel consists of two wheels spaced to opposing sides of the chassis.

7. The modular portable tree hunting stand of claim 4 wherein said means for supportively conveying the chassis member over terrain comprises one or more skis, the skis removably secured to a bottom portion of the adapted frame member.

8. The modular portable tree hunting stand of claim 4 wherein one ladder-like frame member further comprises two or more guard rail members, each guard rail member secured to and aligned with the elongated leg member, the guard members cooperating with the platform member to retain hunter's gear and game in place on the hunting stand and chassis during transport into or out of the hunting site.

9. The modular portable tree hunting stand of claim 8 wherein the one or more ladder-like frame members comprises a lower frame member having a top end removably, supportively and rigidly joinable to a lower portion of a middle frame member, the middle frame member having a top end removably, supportively and rigidly joinable to a lower portion of an upper frame member, the upper frame member having a top end with the platform member rigidly secured thereto, the frame members when joined forming a continuous ladder-like frame structure providing an elevated hunting perch for a hunter.

10. The modular portable tree hunting stand of claim 9 wherein the elongated leg members comprise square metallic tubing having a hollow center therethrough, and wherein the means to removably, supportively and rigidly join comprises a metallic dowel rod secured rigidly to and extending outwards from the interior of an end of a leg member of one frame member, the dowel sized and configured to be supportively and rigidly received into the adjacent joining frame member leg.

11. The modular portable tree hunting stand of claim 10, further comprising a rifle rest secured to the platform.

12. The modular portable tree hunting stand of claim 10, further comprising a bow holder secured to the platform.

13. The modular portable tree hunting stand of claim 10, further comprising a hand brake on the chassis wheels.

14. The modular portable tree hunting stand of claim 10 wherein the platform member comprises a tubular metal selected from the group consisting of steel, an alloy of steel, or aluminum.

15. The modular portable tree hunting stand of claim 14 wherein the one or more ladder-like frame members consists of three ladder-like frame members that when assembled form an overall stand height of 15 feet; wherein the platform member has a width of 2 feet; and wherein said supportive means for conveying comprises an axle and two wheels secured thereto, the wheels and axle configured to support the chassis and facilitate low friction rolling transport over terrain, the wheel and axle assembly removably secured to a bottom portion of the adapted frame member.
